(19) United States
(12) Patent Application Publication
(10) Pub. No.: US 2026/0073172 A1
(43) Pub. Date: Mar. 12, 2026

(54) NON-TRANSITORY COMPUTER-READABLE MEDIUM, PRINT DATA GENERATION METHOD, AND PRINT DATA GENERATION DEVICE

(71) Applicant: MIMAKI ENGINEERING CO., LTD., Nagano (JP)

(72) Inventor: Yuma Asanuma, Nagano (JP)

(73) Assignee: MIMAKI ENGINEERING CO., LTD., Nagano (JP)

(21) Appl. No.: 19/309,620

(22) Filed: Aug. 26, 2025

(30) Foreign Application Priority Data
Sep. 10, 2024 (JP) 2024-156661

(51) Int. Cl. G06K 15/02; H04N 1/60

(52) U.S. Cl. CPC G06K 15/1852; H04N 1/6072

(57) ABSTRACT

A program causes a controller to generate print data and to perform input processing, plate data generation processing, and print data generation processing. The data input processing includes inputting, as input data for performing inserting-component printing, non-variable data corresponding to a shared portion and variable data indicating a variable portion. The plate data generation processing includes plate data for color layer generation processing for generating a plate data for color layer associated with a color layer and plate data for single-color layer generation processing for generating a plate data for single-color layer associated with a single-color layer. The plate data for color layer generation processing includes generating a plate data for color layer by reflecting the variable portion in the variable data. The plate data for single-color layer generation processing includes generating a plate data for single-color layer by reflecting the variable portion in the variable data.

### CROSS REFERENCE TO RELATED APPLICATIONS

This application claims the priority benefit of Japanese Patent Application No. 2024-156661, filed on Sep. 10, 2024. The entirety of the above-mentioned patent application is hereby incorporated by reference herein and made a part of this specification.

### TECHNICAL FIELD

The present disclosure relates to a program, a print data generation method, and a print data generation device.

### DESCRIPTION OF THE BACKGROUND ART

In recent years, a printing apparatus such as an inkjet printer has been widely used. In addition, conventionally, there is known a method of causing a printing apparatus to perform inserting-component printing (variable printing) of creating a plurality of printed matters in which a portion of an image is different (refer to, for example, Japanese Unexamined Patent Publication No. 2022-69096).

### SUMMARY

In recent years, due to the spread of applications of printing apparatuses and the like, it may be required to create more various printed matters by inserting-component printing. Therefore, the present application provides a program, a print data generation method, and a print data generation device that can solve the above problems.

The inventors of the present application have conducted intensive studies on a method for creating various printed matters by inserting-component printing. Then, the inventors considered overlaying another ink layer on a color layer that is an ink layer for drawing an image with a color ink for color printing, and further found that, in this case, if print data is generated by a method the same as or similar to the conventional method, printing may not be appropriately performed. More specifically, for example, in a case of causing a printing apparatus to print an image in which a portion of the image is a variable portion and the other portion is a shared portion (non-variable portion) in the inserting-component printing, it is not common practice to further form another ink layer to be superimposed on a color ink. Therefore, in a case where print data is generated by a method same as or similar to the conventional method, for example, print data in which another ink layer is not formed at a position corresponding to variable data is generated. Further, in this case, for example, in a case where a user specifically gives an instruction for each printed matter, print data can be appropriately generated. However, in this case, labor required for the user becomes enormous, and it becomes difficult to efficiently perform the inserting-component printing. On the other hand, the inventors of the present application have found that, in the case where the above-mentioned other ink layer is a single-color layer formed with a single type of ink, it is possible to readily and appropriately generate print data for various types of inserting-component printing by employing, as input data, non-variable data representing an image corresponding to a shared portion and variable data representing a variable portion, and by reflecting the variable portion of the variable data in both the generation of the plate data for the color layer, which corresponds to the color layer, and the generation of the plate data for the single-color layer, which corresponds to the single-color layer.

In addition, the inventors of the present application have found features necessary for obtaining such effects through further intensive research, and have reached the present disclosure. In order to solve the above problems, the present invention disclosure provides a program for causing a computer to generate print data, the program causing the computer to perform: data input processing of inputting input data for designating a printing operation to be performed by a printing apparatus that performs printing using inks having a plurality of colors; plate data generation processing of generating a plate data that is an image associated with a color of single color ink, the plate data generation processing being processing of generating the plate data according to each color of the inks to be used in the printing apparatus; and print data generation processing of generating the print data based on the plate data generated in the plate data generation processing, in which the print data is data indicating an image to be printed by the printing apparatus, the printing apparatus performs color printing using the inks having the plurality of colors which are basic colors of color representation, the data input processing includes inputting the input data for causing the printing apparatus to perform inserting-component printing for creating a plurality of printed matters in which images to be drawn at a part are different, and inputting, as the input data, non-variable data which is data indicating an image corresponding to a shared portion in the plurality of printed matters and variable data which is data indicating a variable portion as a portion that is individually different in the printed matters, the plate data generation processing includes performing a plate data for color layer generation processing of generating a plate data for color layer, which is a plate data associated with a color layer that is an ink layer to be formed using the inks having the plurality of colors, and performing plate data for single-color layer generation processing of generating a plate data for single-color layer, which is a plate data associated with a single-color layer that is an ink layer to be formed using one color ink separately from the color layer, the plate data for color layer generation processing includes generating the plate data for color layer by reflecting, for each printed matter, the variable portion which is included in the variable data and corresponds to the printed matter, and the plate data for single-color layer generation processing includes generating, for each of the printed matters, the plate data for single-color layer by reflecting the variable portion which is included in the variable data and corresponds to the printed matter.

With the configuration, for example, print data for the inserting-component printing for forming a color layer and a single-color layer can be readily and appropriately generated. Further, thereby, for example, it is possible to cause the printing apparatus to readily and appropriately perform various inserting-component printing. In the configuration, the plate data can be considered as, for example, data which is related to the corresponding ink color and indicates an image to be printed by the printing apparatus. The image to be printed by the printing apparatus can be considered as, for example, an image drawn using the ink corresponding to the plate data. Further, in the configuration, the print data generation processing includes, for example, performing halftone processing based on a plate data. The halftone processing can be considered as, for example, processing of reducing the number of gradations of the image according to the printing operation to be executed by the printing apparatus. Then, in this case, the plate data can also be considered as, for example, an image to be processed for each ink color in the halftone processing.

Further, in the configuration, for example, data of a color image indicating the shared portion is used as the non-variable data. Further, the plate data generation processing further includes, for example, performing single-color image preparation processing. In this case, the single-color image preparation processing includes, for example, preparing a single-color shared image that is a single-color image associated with the shared portion. Further, in this case, the plate data for single-color layer generation processing includes, for example, generating a plate data for single-color layer for each printed matter by inserting a single-color layer variable image, which is an image corresponding to the variable portion in the variable data, into a single-color shared image. With the configuration, for example, a plate data for single-color layer can be appropriately generated. The single-color image preparation processing includes, for example, generating a single-color shared image by performing, on an image that is a source of the single-color shared image, color replacement (color conversion) for replacing any color used in the image with the color of the ink to be used to form a single-color layer. In this case, the single-color image preparation processing includes receiving, as the input data, for example, image data indicating an image that is a source of the single-color shared image, and generating the single-color shared image by performing color replacement on the image. As the image that is a source of the single-color shared image, for example, it is considered to use an image in which the shared portion in which a single-color layer is to be formed is drawn in any one color. With the configuration, for example, the single-color shared image can be appropriately generated by color replacement. Further, the single-color image preparation processing may include, for example, generating a single-color shared image based on the non-variable data. In this case, a color image indicated by the non-variable data may be used as the image that is a source of the single-color shared image. Further, in this case, the single-color image preparation processing includes, for example, generating a single-color shared image by performing color replacement processing on at least one color used in the color image. In a case where the single-color shared image is generated based on the color image indicated by the non-variable data, for example, a single-color shared image in which pixels corresponding to all effective pixels in the color image are effective pixels may be generated.

Further, in the configuration, the printing apparatus is further configured to use, for example, process color inks, which are basic colors for color representation, and special color inks, which are colors other than the process colors. Then, in this case, for example, it is considered to form a special color layer, which is an ink layer to be formed using a special color ink, as the single-color layer. With the configuration, for example, the special color layer in which the variable portion is reflected can be readily and appropriately formed in the inserting-component printing. More specifically, the printing apparatus is configured to use, for example, a light-transmissive medium as a printed medium. Then, in this case, the printing apparatus is further configured to use, for example, at least a light reflective ink as the special color ink. As the light reflective ink, for example, a white ink or the like can be suitably used. Further, in this case, the single-color layer is, for example, a light reflective layer that is an ink layer to be formed using a light reflective ink, and is formed such that at least a portion overlaps at least a portion of the color layer. In this case, the light reflective layer can be considered to function as, for example, a background of the color layer. With the configuration, for example, in a case where the translucent medium is used, the color image represented by the color layer can be appropriately viewed by the observer. As the light-transmissive medium, for example, a transparent film or the like can be suitably used. Further, in this case, the plate data for single-color layer generation processing includes, for example, generating the plate data for single-color layer for each printed matter by reflecting the variable portion in the variable data such that the light reflective layer overlaps at least a part of the portion corresponding to the variable portion in the color layer. With the configuration, for example, the light reflective layer serving as the background of the color layer can be readily and appropriately formed in the portion corresponding to the variable portion. In this case, the plate data for single-color layer generation processing includes, for example, generating a plate data for single-color layer such that the light reflective layer overlaps the entire region corresponding to the variable portion in the color layer. Further, according to the content or the like to be expressed by the variable portion, for example, the plate data for single-color layer generation processing may include generating the plate data for single-color layer such that the light reflective layer overlaps only a part of the portion corresponding to the variable portion in the color layer.

Further, in the configuration, as the variable data, for example, it is considered to use data or the like indicating a variable portion for each printed matter by character information. With the configuration, for example, the variable portion for each printed matter can be appropriately indicated in the variable data. As the variable data, for example, CSV format data (CSV data) or the like can be suitably used. Further, as described above, in the configuration, for example, a single-color shared image is generated by performing color replacement on a color image. Then, in this case, the plate data for single-color layer generation processing includes, for example, as described above, generating the single-color layer variable image corresponding to the variable portion and generating the plate data for single-color layer by performing inserting into the single-color shared image. With the configuration, for example, in a case of combining the generation of the single-color shared image by the color replacement and the use of the variable data indicating the variable portion by the character information, the plate data for single-color layer for each printed matter can be appropriately generated. Further, the single-color shared image preparation processing may include, for example, performing processing of replacing, on an image that is the source of the single-color shared image, any one color used in the image with the color of the ink to be used to form the single-color layer. With the configuration, for example, the single-color shared image can be appropriately generated. Further, in this case, as the variable data, for example, a color image including colors other than the one color may be used as at least a part of the variable portion of at least a portion of the printed matter. The variable portion of the printed matter can be considered as, for example, a portion corresponding to the variable portion indicated by the variable data in the printed matter.

Even in this case, for example, the plate data for single-color layer for each printed matter can be appropriately generated by generating the plate data for single-color layer as described above.

Further, the variable data may indicate, as the variable portion to be reflected at the time of generating the plate data for color layer in the plate data for color layer generation processing, for example, a plurality of types of variable portions for one printed matter. In this case, for example, it is considered to use CSV data or the like including a plurality of items corresponding to a plurality of variable portions as the variable data. Further, in this case, the plate data for single-color layer generation processing may include generating a plate data for single-color layer for each printed matter by reflecting only a part of a plurality of types of variable portions in the variable data. With the configuration, for example, it is possible to easily and appropriately generate a plate data for single-color layer for designating a state where the single-color layer overlaps only a part of the portion corresponding to the variable portion in the color layer. Further, as the configuration of the present disclosure, for example, a print data generation method, a configuration of a print data generation device, and the like having characteristics similar to the above can be considered. Even in these cases, for example, the same effects as described above can be obtained.

According to the present disclosure, for example, it is possible to cause the printing apparatus to easily and appropriately perform various inserting-component printing.

### BRIEF DESCRIPTION OF THE DRAWINGS

FIG. 1A to FIG. 1C are diagrams explaining a printing system 10 using a program according to an embodiment of the present disclosure. FIG. 1A illustrates an example of a configuration of a printing system 10. FIG. 1B illustrates an example of a configuration of a printing apparatus 12 in the printing system 10. FIG. 1C illustrates an example of a configuration of a head unit 102 in the printing apparatus 12.

FIG. 2 is a diagram illustrating an example of the inserting-component printing performed by the printing apparatus 12.

FIG. 3A to FIG. 3C are diagrams explaining the inserting-component printing performed by the printing apparatus 12 in more detail. FIG. 3A illustrates an example of an ink layer formed on the medium 50 by the printing apparatus 12 when the inserting-component printing is performed. FIG. 3B is a diagram explaining a plate data corresponding to a color layer 52. FIG. 3C illustrates an example of an image to be used as a plate data for a white layer 54.

FIG. 4 is a flowchart illustrating an example of an operation of a controller 14.

FIG. 5 is a diagram illustrating an example of a screen for receiving a user's instruction related to color replacement.

FIG. 6A and FIG. 6B are diagrams illustrating an example of an operation of the controller 14 at the time of generating print data corresponding to a printed matter for forming a plurality of single-color layers. FIG. 6A illustrates an example of an operation of generating an image that is a source of a single-color shared image corresponding to a single-color layer having a first color. FIG. 6B illustrates an example of an operation of generating an image that is a source of a single-color shared image corresponding to a single-color layer having a second color.

### DETAILED DESCRIPTION OF EMBODIMENTS

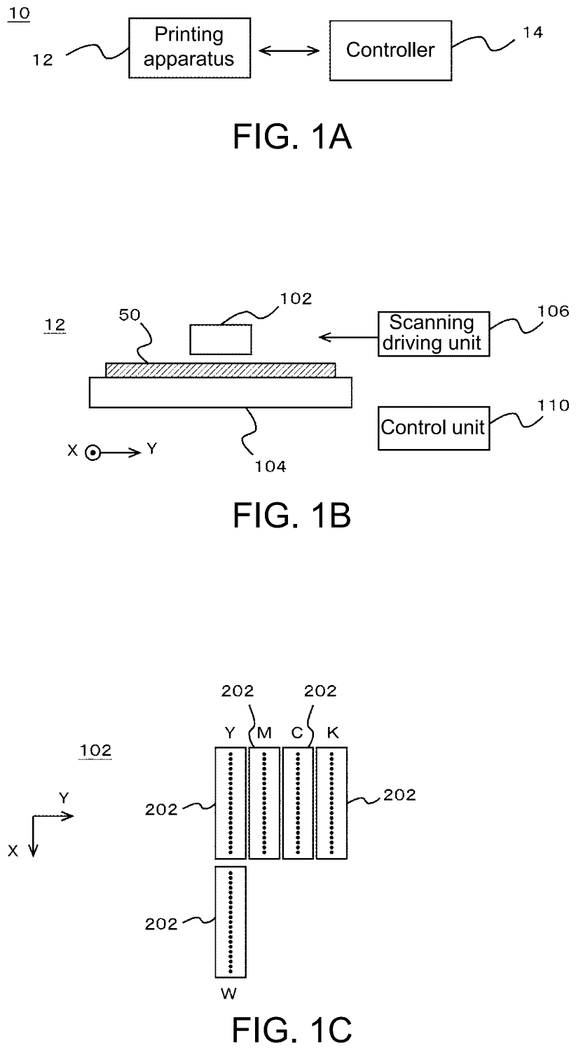

Hereinafter, embodiments according to the present disclosure will be described with reference to the drawings. FIG. 1A to FIG. 1C are diagrams explaining a printing system 10 using a program according to an embodiment of the present disclosure. FIG. 1A illustrates an example of a configuration of a printing system 10. FIG. 1B illustrates an example of a configuration of a printing apparatus 12 in the printing system 10. FIG. 1C illustrates an example of a configuration of a head unit 102 in the printing apparatus 12. Other than points to be described below, the printing system 10 and each unit of the printing system 10 may have features same as or similar to a known printing system and each unit of a known printing system. In the present example, the printing system 10 includes a printing apparatus 12 and a controller 14. The printing apparatus 12 is an apparatus that executes printing based on a control of the controller 14 in the printing system 10. As the printing apparatus 12, for example, a known industrial inkjet printer or the like can be suitably used. Further, in the present example, the printing apparatus 12 is a color printer that performs color printing through an inkjet method using inks of a plurality of colors, and includes, for example, as illustrated in FIG. 1B, a head unit 102, a medium support unit 104, a scanning driving unit 106, and a control unit 110.

The head unit 102 is configured to eject inks onto a medium 50 which is a printing target, and for example, as illustrated in FIG. 1C, includes a plurality of inkjet heads 202. Further, in the present example, the head unit 102 includes inkjet heads 202 for each color of process colors and an inkjet head 202 for a predetermined special color (spot color).

With such a configuration, the printing apparatus 12 performs printing using the process color inks and the special color ink. More specifically, in the present example, the head unit 102 includes inkjet heads 202 for each color of yellow (Y), magenta (M), cyan (C), and black (K), as the inkjet heads 202 for each color of the process colors. Further, the head unit 102 includes an inkjet head 202 for white (W) color ink, as the inkjet head 202 for a special color. In this case, the process colors can be considered as, for example, basic colors of color representation. In addition, the process colors can also be considered as, for example, colors to be used as basic colors for color representation by a subtractive color mixing method in color printing performed in the printing apparatus 12. The process color inks can also be considered as, for example, colored inks to be used as basic colors of color representation. The special color ink can be considered as, for example, an ink of a color different from the color of the process color ink. The special color can also be considered as, for example, a color other than the basic colors for color representation by the subtractive color mixing method. Further, the special color can also be considered as, for example, a color treated as a special color in the specification of the printing apparatus 12. The special color can be considered as, for example, a color other than YMCK (CMYK). In the present example, a white ink is an example of a special color ink and a light reflective ink.

Further, in the present example, each inkjet head 202 includes a nozzle row in which a plurality of nozzles are arranged at positions different from each other in a predetermined sub scanning direction (X direction in FIG. 1C) set in advance in the printing apparatus 12. Among the plurality of inkjet heads 202 in the head unit 102, for example, as illustrated in FIG. 1C, the inkjet heads 202 for each color of the process colors are aligned in the sub scanning direction and are arranged side by side in a main scanning direction (Y direction in FIG. 1C) orthogonal to the sub scanning direction. Further, the inkjet head 202 for the white ink, which is the inkjet head 202 for the special color, is arranged at a position shifted from the inkjet heads 202 for the process colors in the sub scanning direction. In a modification example of the configuration of the head unit 102, the head unit 102 may further include an inkjet head 202 for a special color other than white. In this case, the head unit 102 further includes, for example, an inkjet head 202 for a clear ink, an inkjet head 202 for a primer ink, and the like as the inkjet head 202 for the special color. Further, in this case, the plurality of inkjet heads 202 for the special color are aligned in, for example, the sub scanning direction, and are arranged side by side in the main scanning direction. Further, in a modification example of the configuration of the head unit 102, the inkjet heads 202 for the special color may be aligned and arranged, for example, with the inkjet heads 202 for the process colors in the sub scanning direction.

The medium support unit 104 is a table-shaped member that supports the medium 50 at a position facing the head unit 102. The scanning driving unit 106 is a driving unit that causes the head unit 102 to perform a scanning operation for relative movement with respect to the medium 50. In this case, causing the head unit 102 to perform the scanning operation can be considered as, for example, causing the inkjet head 202 in the head unit 102 to perform the scanning operation. Further, in the present example, the scanning driving unit 106 causes the head unit 102 to perform a main scanning operation and a sub scanning operation as the scanning operation. The main scanning operation can be considered as, for example, an operation (scan operation) of causing the head unit 102 to eject the ink while relatively moving the head unit 102 in the main scanning direction with respect to the medium 50. The sub scanning operation can be considered as, for example, an operation of relatively moving the head unit 102 in the sub scanning direction with respect to the medium 50. For example, the scanning driving unit 106 causes the head unit 102 to perform the sub scanning operation between the main scanning operations, and thus, a portion of the medium 50 facing the head unit 102 is changed in each main scanning operation. The sub scanning operation can also be considered as, for example, a transporting operation (feeding operation) of transporting the medium 50 to the head unit 102.

Further, the control unit 110 is configured to include, for example, a CPU of the printing apparatus 12, and controls an operation of each unit of the printing apparatus 12. In the present example, the control unit 110 receives print data generated in the controller 14 from the controller 14, and controls an operation of each unit of the printing apparatus 12 based on the print data. In the present example, the print data received from the controller 14 by the printing apparatus 12 can be considered as, for example, data of a print job indicating a printed matter to be printed. According to the present example, for example, the printing apparatus 12 can appropriately perform printing on the medium 50. Further, in this case, for example, color printing of drawing a color image on the medium 50 can be appropriately performed by using the ink of each color of the process colors. Further, in this case, for example, various printing using the special color ink can be performed as necessary. In addition to the above configuration, the printing apparatus 12 may further have a configuration same as or similar to a known printing apparatus. For example, the printing apparatus 12 may further include a fixing unit or the like that fixes the ink onto the medium 50. Further, in the present example, the printing apparatus 12 performs inserting-component printing (variable printing) according to the control of the controller 14. The inserting-component printing can be considered as, for example, printing for creating a plurality of printed matters in which images to be drawn at a part are different. Further, the inserting-component printing can also be considered as, for example, printing performed by setting, as print data, a style that becomes variable every time a printed matter is printed.

The controller 14 is a device that controls the operation of the printing apparatus 12, and supplies print data to the printing apparatus 12 to control the operation of the printing apparatus 12. Further, in the present example, the controller 14 is a computer such as a PC that executes a program for generating print data, and generates the print data according to the program. In this case, the controller 14 can also be considered to function as, for example, a print data generation device that executes a print data generation method according to the program. Further, as described above, in the present example, the printing apparatus 12 performs the inserting-component printing. In this case, the controller 14 causes the printing apparatus 12 to perform the inserting-component printing by generating print data for the inserting-component printing and supplying the print data to the printing apparatus 12. The operation of causing the printing apparatus 12 to perform the inserting-component printing and the operation of causing the controller 14 to generate the print data for the inserting-component printing will be described in more detail below.

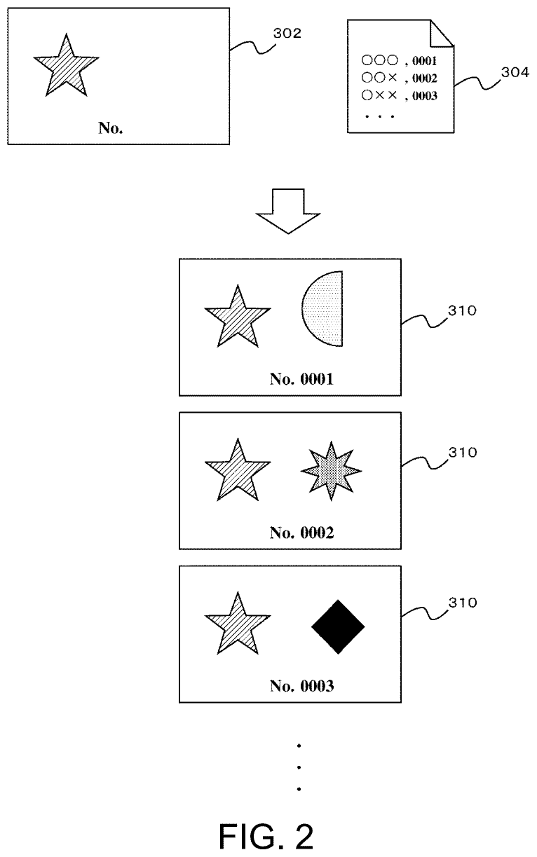

FIG. 2 illustrates an example of the inserting-component printing performed by the printing apparatus 12. In FIG. 2 and subsequent drawings to be described below, for the sake of convenience of illustration, a color difference in an image is illustrated with different shading patterns. In the printing system 10 according to the present example, the controller 14 generates print data for the inserting-component printing based on shared image data 302 and variable data 304. Further, the printing apparatus 12 performs printing based on the print data received from the controller 14, and thus, a plurality of printed matters 310 in which parts are different from each other are created. In this case, the shared image data 302 and the variable data 304 are an example of input data that is input by the controller 14.

The shared image data 302 is an example of non-variable data, and indicates an image corresponding to a shared portion in the plurality of printed matters 310 created by the inserting-component printing. In the present example, the shared image data 302 is, for example, image data indicating a color image in a known format. Further, the variable data 304 is data indicating a variable portion that is a portion which is individually different in the printed matters 310 created by the inserting-component printing. As the variable data 304, for example, it is considered to use data or the like indicating a variable portion for each printed matter 310 by character information. With the configuration, for example, the variable portion for each printed matter 310 can be appropriately indicated by the variable data 304 having a small data amount. As such variable data 304, for example, data in a text format or the like can be suitably used. Further, in the present example, for example, data in a CSV format or the like is used as the variable data 304. In this case, in the variable data 304, for example, one row is associated with one printed matter 310, and a variable portion corresponding to the printed matter 310 is indicated by character information in a row corresponding to the printed matter 310. More specifically, for example, in a case where characters and numbers different for each printed matter 310 are drawn on the variable portion, it is considered that the characters and numbers are indicated by text data in the variable data 304. Further, for example, in a case where an image different for each printed matter 310 is drawn in the variable portion, it is considered to indicate a character string for designating a place where the image is stored in the variable data 304. As the place where the image is stored, for example, it is considered to indicate a path in a computer, a URL on the Internet, or the like. Furthermore, the variable data 304 may indicate, for example, a plurality of types of variable portions for one printed matter 310. In this case, for example, it is considered that a plurality of types of variable portions are indicated by separating the variable portions by using, as illustrated in FIG. 2, commas on a row for each printed matter 310 in the CSV format data. Furthermore, in this case, the variable data 304 can also be considered as data including, for example, a plurality of items corresponding to the plurality of variable portions.

More specifically, in a case of the example illustrated in FIG. 2, the shared image data 302 indicates an image indicating a star-shaped pattern (style) and an image indicating a character string No. In addition, the variable data 304 indicates an image indicating a pattern individually used for each printed matter 310 and a character string individually used for each printed matter 310. Further, as described above, in the present example, the variable data 304 indicates the variable portion for each printed matter 310 by the character information. Therefore, the variable data 304 relates to an image indicating a pattern for each printed matter 310, and indicates, for example, a character string for designating a place where the image is stored. Further, the variable data 304 directly indicates, for example, the character string for each printed matter 310. Then, the controller 14 generates print data for causing the printing apparatus 12 to perform the inserting-component printing based on the shared image data 302 and the variable data 304. In addition, the controller 14 supplies the print data to the printing apparatus 12, and thus the printing apparatus 12 is caused to create, for example, as illustrated in FIG. 2, a plurality of printed matters 310 in which portions are different from each other.

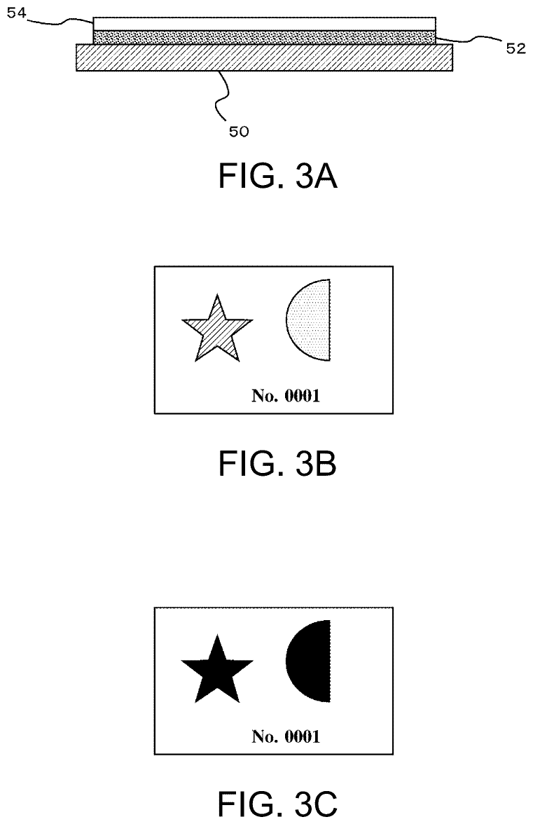

Furthermore, in the present example, for example, as illustrated in FIG. 3A to FIG. 3C, the controller 14 causes the printing apparatus 12 (refer to FIG. 1A) to perform the inserting-component printing using the special color ink. FIG. 3A to FIG. 3C are diagrams explaining the inserting-component printing performed by the printing apparatus 12 in more detail. FIG. 3A illustrates an example of an ink layer formed on the medium 50 by the printing apparatus 12 when the inserting-component printing is performed. In the present example, the printing apparatus 12 uses, for example, a translucent medium as the medium 50. As the light-transmissive medium 50, for example, a transparent film or the like can be suitably used. Then, the printing apparatus 12 forms, for example, a color layer 52 and a white layer 54 on the medium 50 in an overlapping manner. In this case, the color layer 52 is an ink layer formed using the process color ink. The color layer 52 can also be considered as, for example, an ink layer on which a color image is drawn. Further, the color layer 52 can also be considered as, for example, an ink layer on which a color image to be visually recognized by an observer for the printed matter is drawn. Further, the white layer 54 is an ink layer formed of a white ink that is a light reflective ink. In this case, the white layer 54 can also be considered as, for example, a light reflective layer formed of a light reflective ink. Further, in the present example, the white layer 54 is an example of a single-color layer and a special color layer. The single-color layer can be considered as, for example, an ink layer formed by one color ink separately from the color layer 52. Further, the single-color layer can also be considered as, for example, an ink layer formed using only the ink ejected from one inkjet head 202 (refer to FIG. 1C). The special color layer can be considered as, for example, an ink layer formed using a special color ink. In the present example, forming the special color layer using the special color ink can be considered as, for example, forming the special color layer using only the special color ink which has one color and is ejected from one inkjet head 202. In this case, the special color layer can also be considered as, for example, a single-color layer formed using a special color ink.

Further, in the present example, the white layer 54 is formed such that at least a portion of the white layer 54 overlaps at least a portion of the color layer 52. In this case, the white layer 54 can be considered to function as, for example, a background of the color layer 52. With the configuration, for example, even in a case where the translucent medium 50 is used, the color image represented by the color layer 52 can be appropriately viewed by the observer. Further, as described above, in the present example, the controller 14 causes the printing apparatus 12 to perform the inserting-component printing, and thus the printing apparatus 12 is caused to create a plurality of printed matters in which images to be drawn at a part are different. In this case, the printing apparatus 12 forms the color layer 52 and the white layer 54 in an overlapping manner even in at least a part of the variable portion of the printed matter. The variable portion of the printed matter can be considered as, for example, a portion corresponding to the variable portion indicated by the variable data in the printed matter. With the configuration, for example, the variable portion in the printed matter can be visually recognized by the observer as appropriate. Further, in this case, the portion corresponding to the variable portion indicated by the variable data in the ink layer of the printed matter can be considered as, for example, a variable portion of the ink layer.

Further, as described above, in the present example, the controller 14 supplies the print data to the printing apparatus 12 to control the operation of the printing apparatus 12. Then, in this case, for example, the controller 14 generates a plate data corresponding to each color ink to be used for printing based on the shared image data and the variable data, and generates the print data based on the plate data. The plate data can be considered as, for example, data which is related to the corresponding ink color and indicates an image to be printed by the printing apparatus 12. The plate data can also be considered as, for example, an image associated with the color of single color ink. Further, in the present example, the controller 14 generates a grayscale image as a plate data for each ink color to be used for printing. The grayscale image can be considered as, for example, a single-color image indicating a pixel value of each pixel using multiple gradations larger than 2. The controller 14 generates, for example, a multi-gradation grayscale image of approximately 4 bits to 16 bits (for example, approximately 8 bits) as a plate data. Further, in the present example, the controller 14 generates print data by performing halftone processing based on the plate data during an operation of raster image processor (RIP) processing. The halftone processing can be considered as, for example, processing of reducing the number of gradations of the image according to the printing operation to be executed by the printing apparatus 12. More specifically, the controller 14 performs, for example, processing of binarizing the multi-gradation grayscale image, as the halftone processing based on the plate data. Then, in this case, the plate data can also be considered as, for example, an image to be processed for each ink color in the halftone processing. Further, in this case, for example, as illustrated in FIG. 3B and FIG. 3C, the controller 14 generates a plate data corresponding to the color layer 52 and the white layer 54 for each printed matter to be created by the printing apparatus 12.

FIG. 3B is a diagram explaining a plate data corresponding to the color layer 52, and illustrates an example of a state before a plurality of plate data to be formed for the color layer 52 are separated for each ink color, focusing on one printed matter to be created by the printing apparatus 12. In the present example, the controller 14 generates a plate data for each ink color to be used for forming the color layer 52 as a plate data for the color layer 52. In this case, the controller 14 generates, for example, a plate data for each color of the process colors. More specifically, in this case, for example, the controller 14 generates a plate data for each ink color by performing separation processing of separating the color image illustrated in FIG. 3B for each ink color. Further, thereby, the controller 14 generates a plurality of plate data associated with different colors, as plate data for the color layer 52. In this case, the plurality of plate data are an example of plate data for color layer. The plate data for color layer can be considered as, for example, a plate data associated with the color layer 52 to be formed using a plurality of color inks. In the present example, the controller 14 generates a plate data for the color layer 52, for example, in the same manner as or similar to the operation in the case of generating print data for the inserting-component printing for forming only the color layer 52 on the medium 50. In this case, as the operation of forming the plate data for the color layer 52, the controller 14 performs, for example, an operation same as or similar to the case of causing the printing apparatus 12 to perform the inserting-component printing by a known method.

Further, in the present example, the controller 14 generates, for example, an image illustrated in FIG. 3C, as a plate data corresponding to the white layer 54. FIG. 3C illustrates an example of an image to be used as a plate data for the white layer 54, for one printed matter to be created by the printing apparatus 12. In this case, the plate data for the white layer 54 is an example of a plate data for special color layer. Further, the plate data for special color layer is an example of a plate data for single-color layer. The plate data for single-color layer can be considered as, for example, a plate data associated with a single-color layer. The plate data for special color layer can be considered as, for example, a plate data associated with the special color layer. For example, the controller 14 generates a plate data for the white layer 54 based on an image that is a source of the plate data for the white layer 54 and the variable data.

In this case, it can also be considered that the controller 14 generates a plate data for the white layer 54 based on at least the variable data. As the image that is a source of the plate data for the white layer 54, for example, it is considered to use an image indicating an image corresponding to the image indicated by the shared image data by using only one color. In this case, the controller 14 may generate an image that is a source of the plate data for the white layer 54, for example, based on the shared image data. The operation of generating the plate data for the single-color layer, such as the plate data for the white layer 54, in the controller 14 will be described in more detail later in association with a description of an operation of generating print data in the controller 14.

Here, as described above, in the present example, the printing apparatus 12 forms the color layer 52 and the white layer 54 in an overlapping manner even in at least a part of the variable portion of the printed matter. In this regard, forming the white layer 54 in the variable portion may seem obvious at a glance. However, in the case of performing the inserting-component printing, forming a single-color layer such as the white layer 54 on the color layer 52 in an overlapping manner is an operation different from the operation in a case of performing general inserting-component printing.

Therefore, in the case of generating print data for the inserting-component printing by a conventional method, for example, even in a case where it is designated to form a single-color layer other than the color layer 52 at the time of designating a printing condition, usually, a single-color layer is not formed in the variable portion, and a single-color layer is formed only in the shared portion of the plurality of printed matters. More specifically, in a case where it is designated to form a single-color layer overlapping the color layer 52 at the time of designating a printing condition of printing to be performed by the printing apparatus 12, for example, a plate data for single-color layer is generated by performing, on an image indicating a range in which the single-color layer is to be formed, color replacement (single-color conversion) according to the ink color to be used for forming the single-color layer. Then, in the case of generating print data for the inserting-component printing, for example, when the controller 14 having a conventional configuration attempts to generate a plate data for single-color layer, such color replacement is usually performed on an image indicating a shared portion in the inserting-component printing. Further, as a result, the plate data for single-color layer is generated according to an operation of forming a single-color layer only in a shared portion of the plurality of printed matters. Further, as in the present example, in a case where data or the like indicating a variable portion by character information is used as variable data, in the controller 14 having the conventional configuration, normally, it can be considered that the variable portion is not a target of color replacement.

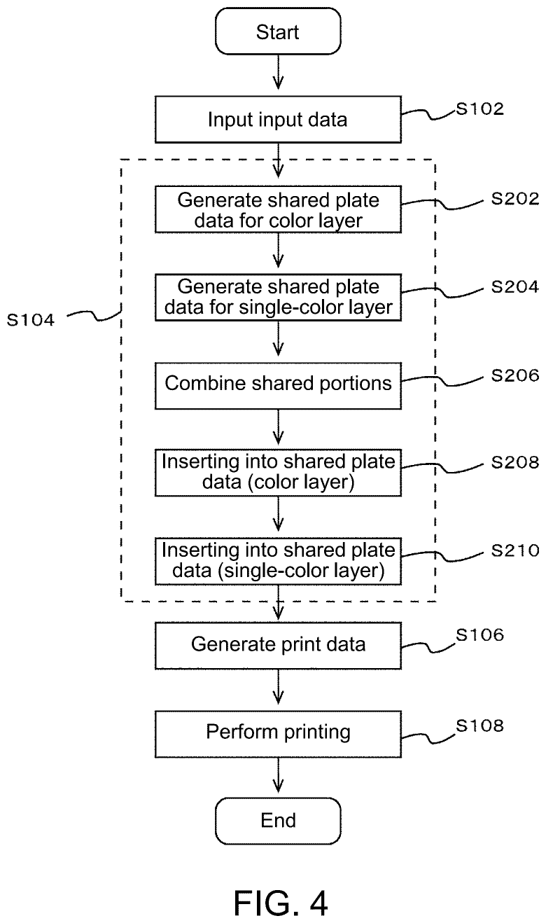

On the other hand, in the present example, the controller 14 generates the print data such that a single-color layer such as a white layer is also formed in a variable portion in the inserting-component printing, for example, by an operation of a flowchart illustrated in FIG. 4. FIG. 4 is a flowchart illustrating an example of the operation of the controller 14, and illustrates an example of the operation performed by the controller 14 according to a program for generating print data. For convenience of illustration and description, FIG. 4 illustrates an example of the operation of the controller 14 focusing on the operation of generating print data corresponding to one of the plurality of printed matters to be created by the printing apparatus 12 by the inserting-component printing. In the operation of actually generating the print data for the inserting-component printing, the controller 14 generates the print data corresponding to the plurality of printed matters by repeatedly executing a part of the operation illustrated in FIG. 4. In addition, the order in which the operations of the respective steps illustrated in the flowchart of FIG. 4 are performed and the specific operations performed in the respective steps may be appropriately changed. Furthermore, in a case where the printing apparatus 12 is not caused to perform the inserting-component printing, the controller 14 generates the print data by, for example, an operation same as or similar to the operation in which a part of the operation illustrated in FIG. 4 is omitted. More specifically, in this case, the controller 14 generates the print data by, for example, an operation same as or similar to the operation in which step S208 and step S210 in FIG. 4 are omitted.

Further, in the operation illustrated in FIG. 4, the controller 14 first inputs input data for designating a printing operation to be performed by the printing apparatus 12 (step S102). The operation of step S102 is an example of an operation in the data input processing and the data input step. Further, in the present example, the controller 14 inputs the shared image data and the variable data, as input data for causing the printing apparatus 12 to perform the inserting-component printing. Then, the controller 14 generates a plate data according to the ink color to be used in the printing apparatus 12 based on these pieces of input data (S104). The operation of step S104 is an example of an operation in the plate data generation processing and the plate data generation stage. The operation performed by the controller 14 in step S104 will be described in more detail later. Further, subsequent to the operation in step S104, the controller 14 generates print data based on the plate data generated in step S104 (step S106). The operation of step S106 is an example of an operation in the print data generation processing and the print data generation stage. In the present example, the controller 14 generates print data by performing halftone processing based on a plate data corresponding to each color ink, processing of converting data into commands according to the printing apparatus 12, and the like. In this case, the print data can be considered as, for example, data indicating an image to be printed by the printing apparatus 12. Further, in the present example, the controller 14 generates print data for each printed matter to be created by the printing apparatus 12 in the operation for, for example, the inserting-component printing. In this case, it can be considered that the controller 14 generates, for example, a plurality of pieces of print data corresponding to the plurality of printed matters. In addition, the controller 14 supplies the print data to the printing apparatus 12 to cause the printing apparatus 12 to execute the printing operation corresponding to each printed matter in the inserting-component printing (S108). The operation of step S108 is an example of an operation in the print execution processing and the print execution stage. According to the present example, for example, the printing apparatus 12 can be caused to appropriately perform the inserting-component printing.

Next, the operation performed by the controller 14 in step S104 will be described in more detail. In the present example, the controller 14 generates, for example, print data for forming a color layer and a single-color layer on a medium. Therefore, in step S104, the controller 14 generates a plate data for color layer and a plate data for single-color layer such as a white layer.

In this case, the controller 14 generates, as the plate data for color layer, a plate data corresponding to, for example, each color of the process colors. Further, the controller 14 generates, as a plate data for single-color layer, a plate data for single-color layer corresponding to, for example, a white layer. More specifically, in this case, for example, the controller 14 generates a shared plate data for color layer, which is a plate data indicating a shared portion in the color layer, based on the shared image data (S202). The operation of step S202 is an example of an operation in the color shared image generation processing and the color shared image generation stage. The shared portion in the color layer can be considered as, for example, a shared portion in the color layer of the plurality of printed matters to be created by the inserting-component printing. The shared plate data for color layer can be considered as, for example, an image corresponding to the plate data for the color layer before inserting of the variable portion. The controller 14 generates the shared plate data for color layer corresponding to each color of the process colors by performing, on the image indicated by the shared image data, for example, adjustment of the resolution according to the resolution of printing or separation processing according to the colors of the inks to be used for forming the color layer.

Further, in the present example, the controller 14 further generates a shared plate data for single-color layer that is a plate data indicating a shared portion in the single-color layer (S204). The operation of step S204 is an example of an operation in the single-color image preparation processing and the single-color image preparation stage. The shared portion in the single-color layer can be considered as, for example, a shared portion in the single-color layer of the plurality of printed matters to be created by the inserting-component printing. The shared plate data for single-color layer can be considered as an image corresponding to the plate data for a single-color layer before inserting of the variable portion. Further, in the present example, the shared plate data for single-color layer is an example of a single-color shared image. The single-color shared image can be considered as, for example, a single-color image associated with the shared portion in the plurality of printed matters. For example, the controller 14 generates the shared plate data for single-color layer by performing, on the image that is a source of the shared plate data for single-color layer, color replacement for replacing at least one color of the colors used in the image with the ink color to be used to form the single-color layer. In this case, the controller 14 generates, as the shared plate data for single-color layer, a grayscale image corresponding to, for example, the color of the single-color layer. Further, for example, the controller 14 receives an instruction to designate a color of the replacement source and a color after the replacement from the user, and performs color replacement (single-color conversion) on the image that is a source of the shared plate data for single-color layer based on the instruction. Further, the controller 14 generates a shared plate data for single-color layer by performing, on the image after the color replacement, for example, adjustment of the resolution according to the resolution of the printing as necessary. With the configuration, for example, the shared plate data for single-color layer can be easily and appropriately generated.

Further, in the present example, the controller 14 uses, as an image that is a source of the shared plate data for single-color layer, for example, an image (color image) in which the shared portion in which the single-color layer is to be formed is drawn in a predetermined color. As the image, for example, it is considered to use an image in which the shared portion in which a single-color layer is to be formed is drawn in any one color. As the one color, for example, any one color (for example, K color) of the process colors can be suitably used. In step S204, the controller 14 receives, as the input data, for example, image data indicating an image that is a source of the single-color shared image, and generates the single-color shared image by performing color replacement on the image. In this case, the controller 14 may receive the image data indicating the image that is a source of the single-color shared image, for example, during the operation of step S102 described above. Further, the controller 14 may use, as the image that is a source of the single-color shared image, for example, a color image indicated by the shared image data. In this case, for example, the controller 14 generates a single-color shared image by performing color replacement processing on at least one color used in the color image. Further, the controller 14 may generate an image that is a source of the single-color shared image in the controller 14. In this case, the controller 14 may generate an image that is a source of the single-color shared image from the color image indicated by the shared image data by using, for example, a plate data generation function of generating a plate data for a special color based on the color image. Also in this case, for example, the single-color shared image can be appropriately generated by performing color replacement or the like on the image. In a case where the single-color shared image is generated based on the color image indicated by the shared image data, for example, it is preferable to generate a single-color shared image in which pixels corresponding to all effective pixels in the color image are effective pixels.

Further, the controller 14 performs combination of shared portions of the pieces of print data corresponding to the plurality of printed matters by combining the shared plate data for color layer and the shared plate data for single-color layer generated in step S202 and step S204 (S206). The operation of step S206 is an example of an operation in the shared portion combination processing and the shared portion combination operation. In step S206, the controller 14 performs combination of the shared portions of the pieces of print data by associating, for example, the shared plate data for color layer with the shared plate data for single-color layer, and designating, for the color layer shared plate data for and the single-color layer shared plate data for, the ink layers to be formed in an overlapping manner at the time of printing, the overlapping manner (stacking order), and the like. Further, thereby, the controller 14 generates shared portion data which is data as a target of inserting of the variable portion that is to be performed later. The shared portion data can be considered as, for example, shared data that is a source of the print data for each printed matter. Further, the combination operation performed by the controller 14 in step S106 can also be considered to correspond to, for example, an operation of combining print jobs. In this case, for example, it can be considered that the controller 14 generates a combination job which is a source of print data for each printed matter by combining a print job corresponding to the shared portion of the color layer and a print job corresponding to the shared portion of the single-color layer.

Further, subsequent to the operation in step S206, the controller 14 generates a plate data for color layer by performing inserting into the shared plate data for color layer based on the variable data (S208). The operation of step S208 is an example of an operation in the plate data for color layer generation processing and the plate data for color layer generation stage. In step S208, for example, the controller 14 generates an image indicating a pattern, a character, or the like to be reflected on the plate data for color layer based on the variable data, performs separation on the image according to the shared plate data for color layer corresponding to each color of the process colors, and performs inserting into the shared plate data for color layer corresponding to each color. In step S108 of the present example, the controller 14 generates a plate data for color layer by performing, for example, the operation same as or similar to the operation in the case of causing the printing apparatus 12 to perform the inserting-component printing by a known method. Further, as described above, in the present example, the controller 14 generates pieces of print data corresponding to the plurality of printed matters by repeatedly executing a part of the operation illustrated in FIG. 4. More specifically, in the present example, the controller 14 generates pieces of print data corresponding to the plurality of printed matters by repeating the operations of step S208 and the subsequent steps in step S104 and the operations of step S106 and step S108. Further, in this case, in step S108, the controller 14 generates a plate data for color layer by reflecting, for each printed matter, the variable portion corresponding to the printed matter in the variable data. Reflecting the variable portion corresponding to the printed matter in the variable data can be considered as, for example, reflecting the item indicated by the variable data as the variable portion of the printed matter.

Further, in the present example, the controller 14 generates a plate data for single-color layer by further performing inserting into the shared plate data for single-color layer based on the variable data (S210). The operation of step S210 is an example of an operation in the plate data for single-color layer generation processing and the plate data for single-color layer generation stage. In step S210, for example, the controller 14 generates a single-color layer variable image that is an image indicating a pattern, a character, or the like to be reflected on the plate data for single-color layer based on the variable data, and generates a plate data for single-color layer by inserting the single-color layer variable image into the shared plate data for single-color layer. Further, thereby, the controller 14 generates the plate data for single-color layer by reflecting, for each printed matter, the variable portion corresponding to the printed matter in the variable data. In this case, the single-color layer variable image can be considered as, for example, an image corresponding to the variable portion in the variable data. Further, as described above, in the present example, the controller 14 generates, as the shared plate data for single-color layer, for example, a grayscale image corresponding to the color of the single-color layer. Then, in this case, in step S210, the controller 14 generates, as the single-color layer variable image, for example, a grayscale image corresponding to the variable portion in the variable data. Then, for example, the controller 14 generates a plate data for single-color layer of the grayscale image by inserting the single-color layer variable image into the single-color shared image. Further, in the present example, the controller 14 reflects at least a part of the variable portion indicated by the variable data both at the time of generating the plate data for color layer in step S208 and at the time of generating the plate data for single-color layer in step S210. In this case, in step S210, for example, the controller 14 generates, for each printed matter, the plate data for single-color layer by reflecting the variable portion such that the single-color layer overlaps at least a part of the portion corresponding to the variable portion in the color layer. According to the present example, for example, the single-color layer overlapping a style or the like in the variable portion can be automatically and appropriately formed. Further, as described above, for example, it is considered to form a white layer or the like, which is a layer of a light reflective ink, as the single-color layer. With the configuration, for example, the white layer or the like serving as the background of the color layer can be easily and appropriately formed in the portion corresponding to the variable portion in the printed matter. In this case, for example, the controller 14 generates a plate data for single-color layer such that a single-color layer such as a white layer overlaps the entire region corresponding to the variable portion in the color layer. Further, according to the content or the like to be expressed by the variable portion, for example, the controller 14 may generate the plate data for single-color layer such that the single-color layer overlaps only a part of the portion corresponding to the variable portion in the color layer.

Further, as described above, for example, CSV format data or the like can be suitably used as the variable data. Then, in this case, the variable data can be considered to have, for example, a plurality of items corresponding to a plurality of variable portions. Further, in this case, the variable data may indicate, as the variable portion to be reflected at the time of generating the plate data for color layer in step S208, for example, a plurality of types of variable portions for one printed matter. In this case, in step S210, the controller 14 generates a plate data for single-color layer by reflecting, for example, the same variable portion as in step S208. With the configuration, for example, it is possible to appropriately generate a plate data for single-color layer for designating a state where the single-color layer overlaps the entire region corresponding to the variable portion in the color layer. Further, in step S210, for example, the controller 14 may generate a plate data for single-color layer for each printed matter by reflecting only a part of a plurality of types of variable portions in the variable data. With the configuration, for example, it is possible to appropriately generate a plate data for single-color layer for designating a state where the single-color layer overlaps only a part of the portion corresponding to the variable portion in the color layer.

Further, after generating the plate data for color layer and the plate data for single-color layer in step S208 and step S210, the controller 14 proceeds to step S106 described above, and generates print data for each printed matter by performing halftone processing or the like based on the plate data corresponding to each color ink. The operation of generating the print data by the controller 14 can be considered as, for example, an operation of generating a print job to be executed by the printing apparatus 12. Further, after generating the print data in step S106, as described above, the controller 14 supplies the print data to the printing apparatus 12 in step S108 to cause the printing apparatus 12 to execute the printing operation corresponding to the print data. According to the present example, for example, print data for the inserting-component printing for forming a color layer and a single-color layer can be easily and appropriately generated. Further, thereby, for example, it is possible to cause the printing apparatus 12 to easily and appropriately perform various inserting-component printing.

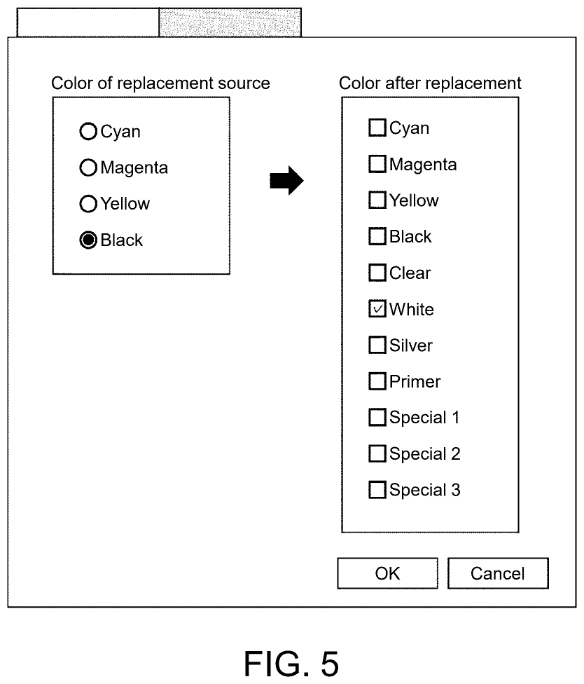

Subsequently, supplementary explanation related to the matters described above, explanation of modification examples, and the like will be made. As described above, in the present example, the controller 14 generates the shared plate data for single-color layer by performing, on the image that is a source of the shared plate data for single-color layer, color replacement for replacing at least one color of the colors used in the image with the ink color to be used to form the single-color layer. Then, in this case, the controller 14 receives an instruction to designate the color of the replacement source and the color after the replacement from the user by presenting, for example, a screen illustrated in FIG. 5 to the user. FIG. 5 illustrates an example of a screen for receiving a user's instruction related to color replacement. In the illustrated example, the controller 14 receives, from the user, an instruction to select, as the color of the replacement source, any one color from each color of CMYK that are the process colors. Further, the controller 14 receives, from the user, an instruction to select, as the color after the replacement, at least one color from among a plurality of colors including the process colors and the special color. More specifically, for example, in a case of generating one shared plate data for single-color layer corresponding to one single-color layer by color replacement, the controller 14 receives, from the user, an instruction to select any one color as the color after replacement. With the configuration, for example, it is possible to appropriately perform, on an image that is a source of the shared plate data for single-color layer, color replacement for replacing any one color used in the image with the color of the ink to be used to form the single-color layer. Further, thereby, for example, a single-color shared image can be appropriately formed. More specifically, in the case of the example illustrated in FIG. 5, the controller 14 receives, from the user, an instruction to select a K color (black color) as the color before the replacement. In addition, the controller 14 receives, from the user, an instruction to select a white color as the color before the replacement. In this case, the controller 14 performs, on an image that is a source of the shared plate data for single-color layer, color replacement of replacing the K color with the white color based on the instruction received from the user. Further, in this case, the color after the replacement can be considered to correspond to the white layer to be formed as the special color layer. For example, the controller 14 may generate print data corresponding to the printed matter for forming a plurality of single-color layers. In this case, for example, the controller 14 receives, from the user, an instruction to select, as the color after the replacement, a plurality of colors corresponding to a plurality of single-color layers.

Here, as described above, the controller 14 generates the shared plate data for single-color layer by, for example, a method of performing color replacement. With the configuration, for example, the shared plate data for single-color layer can be easily and appropriately generated. Further, thereby, for example, the single-color layer such as the white layer can be appropriately formed in the shared portion in a plurality of printed matters to be created by the inserting-component printing. Further, as in the present example, in the case of performing the inserting-component printing using a single-color layer such as a white layer, in some cases, it is desirable to form a single-color layer not only for the shared portion but also for the variable portion. For example, in the case of forming a color layer and a white layer on a light-transmissive medium as in the printed matter described above, if the white layer is not formed in the variable portion, in some cases, the variable portion in the color layer may not be visually recognized as appropriate. For this reason, for example, in a case where a pattern, a character (for example, a serial number or the like), or the like is drawn in the variable portion of the color layer, it is preferable to also form a white layer at a position where the pattern or the character is drawn. However, in the case of performing the inserting-component printing, it is usually difficult to set the variable portion as a target of color replacement. Further, as a result, it is usually difficult to form a single-color layer in the variable portion by a method of performing color replacement.

More specifically, in the case of performing the inserting-component printing, various images different for each printed matter are drawn in the variable portion. Further, in this case, for example, also in some cases, a color image using various colors may be drawn in the variable portion. Further, for example, a complicated image such as a photograph of a face of a person may be drawn in the variable portion. In this case, the variable data can be considered to indicate, for example, a color image including colors other than one color designated as a replacement source in color replacement, as at least a part of at least the variable portion of the printed matter. Then, in this case, in order to simply perform color replacement on the variable portion as described above, for example, it is necessary to separately prepare an image drawn using the color of the replacement source according to the image drawn in the variable portion. However, in this case, it is necessary to separately prepare such an image for each printed matter of a large number of printed matters to be created by the inserting-component printing, and a large burden is usually imposed on the user. Further, as in the present example, in a case of using the variable data indicating a variable portion for each printed matter by character information, in some cases, it may be difficult to set the variable portion as a target of color replacement also in this respect. For example, in the case of using variable data including text data indicating characters or numbers drawn in the variable portion, it is considered that it becomes difficult to set the text data as a target of color replacement.

Further, as described above, it is also considered to use a color image indicated by the shared image data, as an image that is a source of the shared plate data for single-color layer. Then, in this case, at first glance, for example, it seems to be sufficient to generate an image obtained by inserting the variable portion indicated by the variable data into a color image indicated by the shared image data, and to generate a plate data for single-color layer from the image. However, as described above, a color image using various colors may be drawn in the variable portion. In addition, a complicated image such as a photograph of a face of a person may be drawn in the variable portion. Then, in this case, for example, the image that is a target of the color replacement becomes complicated, and it becomes difficult to predict a result obtained by performing the color replacement on the image. Further, as a result, for example, it becomes difficult to generate a plate data for single-color layer by color replacement. Furthermore, in this case, it is necessary to perform the processing described above by the number of printed matters to be created, and the processing takes a lot of time. Further, in this case, for example, it is considered that many images including a shared portion are generated, the same processing is repeated a plurality of times for the shared portion in many images, and the processing becomes inefficient. More specifically, for example, in a case where n printed matters are created by the inserting-component printing, it is necessary to perform, on an image including a shared portion, color replacement processing n times, and the processing takes a lot of time.

On the other hand, in the present example, for example, even in a case where a color image using various colors is drawn in the variable portion, a case where variable data indicating a variable portion for each printed matter by character information is used, and the like, a plate data for a single-color layer such as a special color layer can be easily and appropriately generated. Further, thereby, for example, the single-color layer other than the color layer can be appropriately formed at the position corresponding to the variable portion in the printed matter without causing the user to be aware of troublesome settings and the like related to the variable portion.

Further, as described above, the controller 14 may cause the printing apparatus 12 to form a single-color layer other than the white layer. More specifically, for example, the controller 14 may cause the printing apparatus 12 to form a special color layer to be formed using a special color ink such as a clear ink, a silver ink, or a primer ink. As the ink for forming the single-color layer, for example, it is considered to use an ink using an adhesive material. Further, in a case of forming the single-color layer using special color inks, and the like, the printing apparatus 12 appropriately includes an inkjet head for the ink to be used to form the single-color layer.

Further, the controller 14 generates a shared plate data for single-color layer by performing, for example, color replacement same as or similar to the operation described above. Then, the controller 14 generates a plate data for single-color layer by performing inserting into the shared plate data for single-color layer based on the variable data in the same or similar manner as the operation described above. With the configuration, for example, the printing apparatus 12 can be caused to appropriately perform the inserting-component printing of forming single-color layers having various colors other than the color layer. Further, a single-color layer such as a special color layer may be formed, for example, to perform various decorations on the variable portion other than the purpose of functioning as a simple background of the color layer. With the configuration, for example, regarding the design representation using the single-color layer in the variable portion, different representations and the like can be appropriately performed for each printed matter. Further, thereby, for example, the inserting-component printing for performing various decorations can be appropriately executed.

In addition, as described above, the controller 14 may generate print data corresponding to the printed matter for forming a plurality of single-color layers. In this case, for example, the controller 14 generates a plurality of shared plate data for single-color layer by generating a shared plate data for single-color layer for each color of the single-color layer. Then, the controller 14 generates a plate data for single-color layer corresponding to the single-color layer of each color by performing inserting into the shared plate data for single-color layer based on the variable data for each color of the single-color layer. In this case, the controller 14 can also be considered to generate, for example, a plurality of plate data for single-color layer corresponding to the plurality of single-color layers based on one piece of variable data. Further, as described above, in the present example, the controller 14 performs inserting into the shared plate data for color layer and inserting into the shared plate data for single-color layer based on, for example, the variable data. In this case, it can also be considered that the controller 14 generates a plate data for color layer and a plate data for single-color layer based on one piece of variable data. In a modification example of the operation of the controller 14, for example, the controller 14 may use the variable data only at the time of generating the plate data for single-color layer, without using the variable data at the time of generating the plate data for color layer, among the plate data for color layer and the plate data for single-color layer. Further, in this case, for example, the controller 14 may generate a plurality of plate data for single-color layer corresponding to a plurality of single-color layers having different colors by reflecting the variable data.

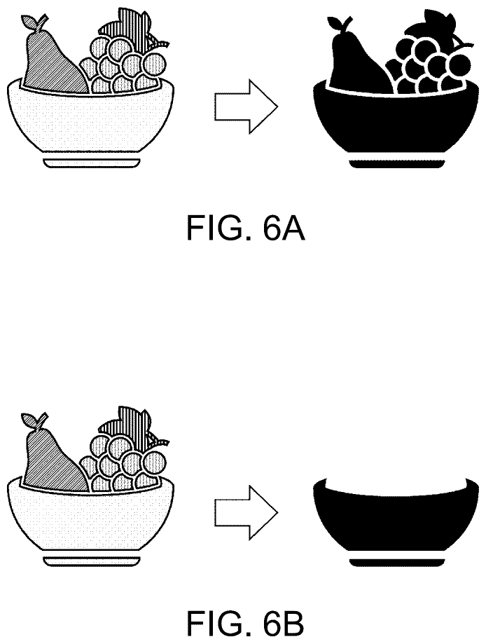

Further, as described above, the controller 14 may generate an image that is a source of the single-color shared image from, for example, the color image indicated by the shared image data. Then, in a case of generating print data corresponding to a printed matter for forming a plurality of single-color layers, the controller 14 may generate different images for each color of the single-color layers, as an image that is a source of the single-color shared image, based on the color image indicated by the shared image data, for example, as illustrated in FIG. 6A and FIG. 6B. FIG. 6A and FIG. 6B illustrate an example of an operation of the controller 14 at the time of generating print data corresponding to a printed matter for forming a plurality of single-color layers. FIG. 6A illustrates an example of an operation of generating an image that is a source of a single-color shared image corresponding to a single-color layer having a first color (for example, a white color). FIG. 6B illustrates an example of an operation of generating an image that is a source of a single-color shared image corresponding to a single-color layer having a second color (for example, a silver color) different from the first color. In FIG. 6A and FIG. 6B, the left diagram illustrates an example of a color image indicated by the shared image data. Further, the right diagram illustrates an example of an image generated by the controller 14 based on the color image that is a source of the single-color shared image. In the case of the example illustrated in FIG. 6A, for example, the controller 14 generates an image that is a source of the single-color shared image by performing color conversion of converting the colors of all the pixels for which any color is set in the color image to a predetermined color (for example, K color). Further, in the case of the example illustrated in FIG. 6B, for example, the controller 14 generates an image different from the case of FIG. 6A, as an image that is a source of the single-color shared image by performing color conversion on only pixels for which a specific color is set in the color image. With the configuration, for example, various images can be appropriately generated as an image that is a source of the single-color shared image based on the color image indicated by the shared image data.

In addition, as described above, for example, it is considered to use, as the variable data, data including a plurality of items corresponding to a plurality of variable portions. Then, in this case, for example, a plate data for single-color layer may be generated by reflecting only the variable portions corresponding to some items.

For example, in a case where formal numbers, characters, and the like such as a serial number are drawn together with a pattern and the like in the variable portion of the color layer, if it is unnecessary to form a single-color layer such as a white layer in a portion such as a serial number, a single-color layer may be formed only in a portion such as a pattern. With the configuration, for example, the consumption amount of the ink to be used to form the single-color layer can be reduced. Further, as described above, in the present example, the print data can be considered as, for example, data of a print job. In this case, the print data for causing the printing apparatus to form the color layer and the single-color layer can be considered to correspond to, for example, a job obtained by combining a job for the color layer (color job) and a job for the single-color layer (single-color job). On the other hand, in the modification example of the operation of the controller 14, for example, the print data may be generated without combining the color job and the single-color job. In this case, the printing apparatus 12 forms the color layer and the single-color layer on the medium by performing a plurality of printing operations including, for example, a printing operation corresponding to the color job and a printing operation corresponding to the single-color job. Then, in this case, for example, the operation of generating the data corresponding to the color job and the single-color job by the controller 14 can be considered to correspond to an operation of generating the print data for the inserting-component printing. Further, in this case, for example, the data obtained by combining the data for the color job and the data for the single-color job can be considered to correspond to the print data for the inserting-component printing for forming the color layer and the white layer.

### INDUSTRIAL APPLICABILITY

The present disclosure can be suitably used for, for example, a program causing a computer to generate print data.

What is claimed is:

1. A non-transitory computer-readable medium storing a program for causing a computer to generate print data, the program causing the computer to perform:
data input processing of inputting input data for designating a printing operation to be performed by a printing apparatus that performs printing using inks having a plurality of colors;
plate data generation processing of generating a plate data that is an image associated with a color of single color ink, the plate data generation processing being processing of generating the plate data according to each color of the inks to be used in the printing apparatus; and
print data generation processing of generating the print data based on the plate data generated in the plate data generation processing, wherein
the print data is data indicating an image to be printed by the printing apparatus,
the printing apparatus is configured to perform color printing using the inks having the plurality of colors which are basic colors of color representation,
the data input processing includes inputting the input data for causing the printing apparatus to perform inserting-component printing for creating a plurality of printed matters in which images to be drawn at a part are different, and inputting, as the input data, non-variable data which is data indicating an image corresponding to a shared portion in the plurality of printed matters and variable data which is data indicating a variable portion as a portion that is individually different in the printed matters,
the plate data generation processing includes
performing plate data for color layer generation processing of generating a plate data for color layer, which is a plate data associated with a color layer that is an ink layer to be formed using the inks having the plurality of colors, and
performing plate data for single-color layer generation processing of generating a plate data for single-color layer, which is a plate data associated with a single-color layer that is an ink layer to be formed using one color ink separately from the color layer,
the plate data for color layer generation processing includes generating the plate data for color layer by reflecting, for each of the printed matters, the variable portion which is included in the variable data and corresponds to the printed matter, and
the plate data for single-color layer generation processing includes generating, for each of the printed matters, the plate data for single-color layer by reflecting the variable portion which is included in the variable data and corresponds to the printed matter.

2. The non-transitory computer-readable medium according to claim 1, wherein
the printing apparatus is configured to use inks having process colors which are basic colors for color representation and inks having a special color which are colors other than the process colors, and
the single-color layer is an ink layer to be formed using the ink having the special color.

3. The non-transitory computer-readable medium according to claim 2, wherein
the printing apparatus is configured to use a light-transmissive medium as a printed medium, and at least uses a light reflective ink as the ink having the special color,
the single-color layer is a light reflective layer that is an ink layer to be formed using the light reflective ink, and is formed such that at least a portion of the single-color layer overlaps at least a portion of the color layer, and
the plate data for single-color layer generation processing includes generating, for each of the printed matters, the plate data for single-color layer such that the light reflective layer overlaps at least a part of the portion corresponding to the variable portion in the color layer by reflecting the variable portion.

4. The non-transitory computer-readable medium according to claim 1, wherein
the plate data generation processing further includes performing single-color shared image preparation processing of preparing a single-color shared image that is a single-color image associated with the shared portion, and
the plate data for single-color layer generation processing includes generating the plate data for single-color layer for each of the printed matters by inserting, into the single-color shared image, a single-color layer variable image which is an image corresponding to the variable portion in the variable data.

5. The non-transitory computer-readable medium according to claim 4, wherein
the single-color shared image preparation processing includes generating the single-color shared image by performing, on an image that is a source of the single-color shared image, color replacement of replacing any color used in the image with a color of the ink to be used to form the single-color layer, and
the variable data is data indicating the variable portion of each of the printed matters by character information.

6. The non-transitory computer-readable medium according to claim 4, wherein
the single-color shared image preparation processing includes generating the single-color shared image by performing, on an image that is a source of the single-color shared image, color replacement of replacing any one color used in the image with a color of the ink to be used to form the single-color layer, and
the variable data indicates a color image including colors other than the one color, as at least a part of the variable portion of at least a portion of the printed matter.

7. The non-transitory computer-readable medium according to claim 1, wherein
the variable data indicates a plurality of types of the variable portions for one printed matter, as the variable portions to be reflected at the time of generating the plate data for color layer in the plate data for color layer generation processing, and
the plate data for single-color layer generation processing includes generating the plate data for single-color layer for each of the printed matters by reflecting only a part of the plurality of types of variable portions in the variable data.

8. A print data generation method for generating print data, the method comprising:
a data input stage of inputting input data for designating a printing operation to be performed by a printing apparatus that performs printing using inks having a plurality of colors;
a plate data generation stage of generating a plate data that is an image associated with a color of single color ink, the plate data generation stage being a stage of generating the plate data according to each color of the inks to be used in the printing apparatus; and
a print data generation stage of generating the print data based on the plate data generated in the plate data generation stage, wherein
the print data is data indicating an image to be printed by the printing apparatus,
the printing apparatus performs color printing using the inks having the plurality of colors which are basic colors of color representation,
the data input stage includes inputting the input data for causing the printing apparatus to perform inserting-component printing for creating a plurality of printed matters in which images to be drawn at a part are different, and inputting, as the input data, non-variable data which is data indicating an image corresponding to a shared portion in the plurality of printed matters and variable data which is data indicating a variable portion as a portion that is individually different in the printed matters,
the plate data generation stage includes
a plate data for color layer generation stage of generating a plate data for color layer, which is a plate data associated with a color layer that is an ink layer to be formed using the inks having the plurality of colors, and
a plate data for single-color layer generation stage of generating a plate data for single-color layer, which is a plate data associated with a single-color layer that is an ink layer to be formed using one color ink separately from the color layer,
the plate data for color layer generation stage includes generating the plate data for color layer by reflecting, for each of the printed matters, the variable portion which is included in the variable data and corresponds to the printed matter, and
the plate data for single-color layer generation stage includes generating, for each of the printed matters, the plate data for single-color layer by reflecting the variable portion which is included in the variable data and corresponds to the printed matter.

9. The print data generation method according to claim 8, wherein
the printing apparatus is configured to use inks having process colors which are basic colors for color representation and inks having a special color which are colors other than the process colors, and
the single-color layer is an ink layer to be formed using the ink having the special color.

10. The print data generation method according to claim 9, wherein
the printing apparatus is configured to use a light-transmissive medium as a printed medium, and at least uses a light reflective ink as the ink having the special color,
the single-color layer is a light reflective layer that is an ink layer to be formed using the light reflective ink, and is formed such that at least a portion of the single-color layer overlaps at least a portion of the color layer, and
the plate data for single-color layer generation stage includes generating, for each of the printed matters, the plate data for single-color layer such that the light reflective layer overlaps at least a part of the portion corresponding to the variable portion in the color layer by reflecting the variable portion.

11. The print data generation method according to claim 8, wherein
the plate data generation stage further includes performing single-color shared image preparation stage of preparing a single-color shared image that is a single-color image associated with the shared portion, and
the plate data for single-color layer generation stage includes generating the plate data for single-color layer for each of the printed matters by inserting, into the single-color shared image, a single-color layer variable image which is an image corresponding to the variable portion in the variable data.

12. The print data generation method according to claim 11, wherein
the single-color shared image preparation stage includes generating the single-color shared image by performing, on an image that is a source of the single-color shared image, color replacement of replacing any color used in the image with a color of the ink to be used to form the single-color layer, and
the variable data is data indicating the variable portion of each of the printed matters by character information.

13. The print data generation method according to claim 11, wherein
the single-color shared image preparation stage includes generating the single-color shared image by performing, on an image that is a source of the single-color shared image, color replacement of replacing any one color used in the image with a color of the ink to be used to form the single-color layer, and
the variable data indicates a color image including colors other than the one color, as at least a part of the variable portion of at least a portion of the printed matter.

14. The print data generation method according to claim 8, wherein
the variable data indicates a plurality of types of the variable portions for one printed matter, as the variable portions to be reflected at the time of generating the plate data for color layer in the plate data for color layer generation stage, and
the plate data for single-color layer generation stage includes generating the plate data for single-color layer for each of the printed matters by reflecting only a part of the plurality of types of variable portions in the variable data.

15. A print data generation device that generates print data, the print data generation device being configured to perform:
data input processing of inputting input data for designating a printing operation to be performed by a printing apparatus that performs printing using inks having a plurality of colors;
plate data generation processing of generating a plate data that is an image associated with a color of single color ink, the plate data generation processing being processing of generating the plate data according to each color of the inks to be used in the printing apparatus; and
print data generation processing of generating the print data based on the plate data generated in the plate data generation processing, wherein
the print data is data indicating an image to be printed by the printing apparatus,
the printing apparatus is configured to perform color printing using the inks having the plurality of colors which are basic colors of color representation,
the print data generation device is configured to, in the data input processing, input the input data for causing the printing apparatus to perform inserting-component printing for creating a plurality of printed matters in which images to be drawn at a part are different, and input, as the input data, non-variable data which is data indicating an image corresponding to a shared portion in the plurality of printed matters and variable data which is data indicating a variable portion as a portion that is individually different in the printed matters,
the print data generation device is configured to, in the plate data generation processing,
perform plate data for color layer generation processing of generating a plate data for color layer, which is a plate data associated with a color layer that is an ink layer to be formed using the inks having the plurality of colors, and
perform plate data for single-color layer generation processing of generating a plate data for single-color layer, which is a plate data associated with a single-color layer that is an ink layer to be formed using one color ink separately from the color layer,
the print data generation device is configured to, in the plate data for color layer generation processing, generate the plate data for color layer by reflecting, for each of the printed matters, the variable portion which is included in the variable data and corresponds to the printed matter, and
the print data generation device is configured to, in the plate data for single-color layer generation processing, generate, for each of the printed matters, the plate data for single-color layer by reflecting the variable portion which is included in the variable data and corresponds to the printed matter.

16. The print data generation device according to claim 15, wherein
the printing apparatus is configured to use inks having process colors which are basic colors for color representation and inks having a special color which are colors other than the process colors, and
the single-color layer is an ink layer to be formed using the ink having the special color.

17. The print data generation device according to claim 16, wherein
the printing apparatus is configured to use a light-transmissive medium as a printed medium, and at least uses a light reflective ink as the ink having the special color,
the single-color layer is a light reflective layer that is an ink layer to be formed using the light reflective ink, and is formed such that at least a portion of the single-color layer overlaps at least a portion of the color layer, and
the plate data for single-color layer generation processing includes generating, for each of the printed matters, the plate data for single-color layer such that the light reflective layer overlaps at least a part of the portion corresponding to the variable portion in the color layer by reflecting the variable portion.

18. The print data generation device according to claim 15, wherein
the plate data generation processing further includes performing single-color shared image preparation processing of preparing a single-color shared image that is a single-color image associated with the shared portion, and
the plate data for single-color layer generation processing includes generating the plate data for single-color layer for each of the printed matters by inserting, into the single-color shared image, a single-color layer variable image which is an image corresponding to the variable portion in the variable data.

19. The print data generation device according to claim 18, wherein
the single-color shared image preparation processing includes generating the single-color shared image by performing, on an image that is a source of the single-color shared image, color replacement of replacing any color used in the image with a color of the ink to be used to form the single-color layer, and
the variable data is data indicating the variable portion of each of the printed matters by character information.

20. The print data generation device according to claim 18, wherein
the single-color shared image preparation processing includes generating the single-color shared image by performing, on an image that is a source of the single-color shared image, color replacement of replacing any one color used in the image with a color of the ink to be used to form the single-color layer, and
the variable data indicates a color image including colors other than the one color, as at least a part of the variable portion of at least a portion of the printed matter.
